(19) United States
(12) Patent Application Publication
(10) Pub. No.: US 2017/0075789 A1
(43) Pub. Date: Mar. 16, 2017

(54) METHOD AND APPARATUS FOR GENERATING, CAPTURING, STORING, AND LOADING DEBUG INFORMATION FOR FAILED TESTS SCRIPTS

(71) Applicant: GOOGLE INC., Mountain View, CA (US)

(72) Inventor: Sonny SKINNER, Redmond, WA (US)

(73) Assignee: GOOGLE INC., Mountain View, CA (US)

(21) Appl. No.: 14/850,255

(22) Filed: Sep. 10, 2015

(51) Int. Cl. G06F 11/36

(52) U.S. Cl. CPC G06F 11/3636; G06F 11/3664

(57) ABSTRACT

A method and system are disclosed for generating, capturing, storing, and loading debug data for a failed test script without user interaction. In an example embodiment, a trace capture component will automatically re-execute a failed test script and capture the execution context information and the source code files associated with the failed test script during the test script's re-execution. The execution context information and associated source code are stored onto a database, or another shared storage medium, and are accessible to multiple users to allow concurrent debugging by multiple users. The captured information allows debugging of the failed test script without requiring access to the original machine or re-execution of the application.

### BACKGROUND

As software becomes more sophisticated, the tools to design, develop, test, and debug it have also become more advanced. Consequently, software developers now increasingly work in teams and rely on development tools, such as debuggers and test scripts to help identify and resolve errors (commonly referred to as “bugs”) in their code.

A debugger, usually part of an integrated development environment solution (IDE), is a tool used to identify and resolve errors in source code. A common component within debuggers is an “execution tracer” which allows the debugger to record, observe, and control the execution of another process, such as the application being developed. While tracing the execution of the application, a debugger can access the “execution context information” of the application as the application is running. The execution context information of an application can include information such as the execution path, method call history, call stack, and values of the local and global variables.

Generally, execution tracing is used in conjunction with “breakpoints.” Trace points and breakpoints are almost synonymous. The primary difference is that trace points are automatically set and handled by an execution tracer. In contrast, a breakpoint waits for the user to resume the application. A breakpoint is a specific point in code that if reached during the execution of the application, will halt the execution of the application at that point and provide the developer with the execution context information. While the execution is halted, the developer can review the execution context information to determine the cause of the error. To continue debugging, the developer may resume the application's execution until another breakpoint is hit or the application has completed execution.

The process of debugging can be very tedious, time consuming, and require multiple cycles of setting breakpoints and executing the application. When a test fails or an application throws an error, the first step for the developer in the debugging process is to identify the areas of code potentially causing the error, manually set breakpoints at those code locations, manually restart the application using the debugger, and then wait for the execution to reach a breakpoint. If a breakpoint is reached, the developer reviews the execution context information of the application at that point to analyze the application's behavior. If the developer is unable to determine the cause of the error, the developer resumes the execution (or, as needed, incrementally proceeds to the next step in the execution) of the application until the execution reaches the next breakpoint or execution has completed.

If unable to resolve the error and the application has terminated, the developer must restart the application using the debugger, and manually set other breakpoints as needed. If other developers want to assist in debugging the application, they must either share access to the local development machine and use the steps described above, or replicate the development environment (i.e. source code, binaries, debugger) on their machines which can be time consuming, resource intensive, and still not necessarily ensure the error would be replicated.

As recognized by the inventor, what is needed is a method or tool to generate, capture, store, and load the debug information necessary to debug an application error or failed test without requiring manual re-executions of the application or access to the local development machine.

### SUMMARY

This specification describes technologies related to debugging software using test scripts, and specifically to methods and systems for capturing, storing, and sharing execution context information for failed test scripts.

In general, one aspect of the subject matter described in this specification can be embodied in methods and components for integrating software test scripts and capturing and storing debugging data without requiring user interaction. An example component includes one or more processing devices and one or more storage devices storing instructions that, when executed by the one or more processing devices, cause the one or more processing devices to implement an example method. An example method may include executing a software test script; and responsive to a non-successful execution of the software test script, re-executing, without user interaction, the test script; capturing, without user interaction, the trace and associated source code data of the execution of the test script; and storing, without user interaction, the trace and associated source code data of the test script.

These and other embodiments can optionally include one or more of the following features: a non-successful execution may include a failure of a test; a non-successful execution may include a timeout of a test; loading the stored trace and associated source code data for debugging on a remote development environment; storing and accessing the trace and associated source code data from a database; storing and accessing the trace and associated source code data from a local development environment; providing concurrent access to stored trace and associated source code data to multiple users via storage medium like a database; displaying the trace and associated source code data to a user; displaying the trace and associated source code data in an integrated development environment (IDE).

The details of one or more embodiments of the invention are set forth in the accompanying drawings which are given by way of illustration only, and the description below. Other features, aspects, and advantages of the invention will become apparent from the description, the drawings, and the claims. Like reference numbers and designations in the various drawings indicate like elements

### BRIEF DESCRIPTION OF DRAWINGS

FIG. 1 is a diagram illustrating a local development environment containing the source code files, binary files, unit test files, the debugger, and a trace capture component which performs the method described herein. Also illustrated is a server which hosts a database containing the debug data.

FIG. 2 is an example source code file of a class declaring three methods.

FIG. 2A is the example source code of a method, MethodA, declared in FIG. 2.

FIG. 3A is an example of an execution of a unit test for MethodA that returns “SUCCESS”.

FIG. 3B is an example of an execution of a unit test for MethodA that returns “FAIL”.

FIG. 4 is a flow diagram of a conventional method of a developer debugging a unit test.

FIG. 5 is a flow diagram of an example method for generating, capturing, and storing the debug data of a unit test without requiring any user interaction.

FIG. 6 is a diagram illustrating the debug data stored on a database that is accessible to multiple remote users/developers.

FIG. 7 is a flow diagram of a method of a developer debugging a unit test without requiring access to the local development environment or re-execution of the application.

FIG. 8 is a screenshot of a user interface of an IDE debugging a unit test in local development environment.

FIG. 9 is a block diagram illustrating an exemplary computing device

### DETAILED DESCRIPTION

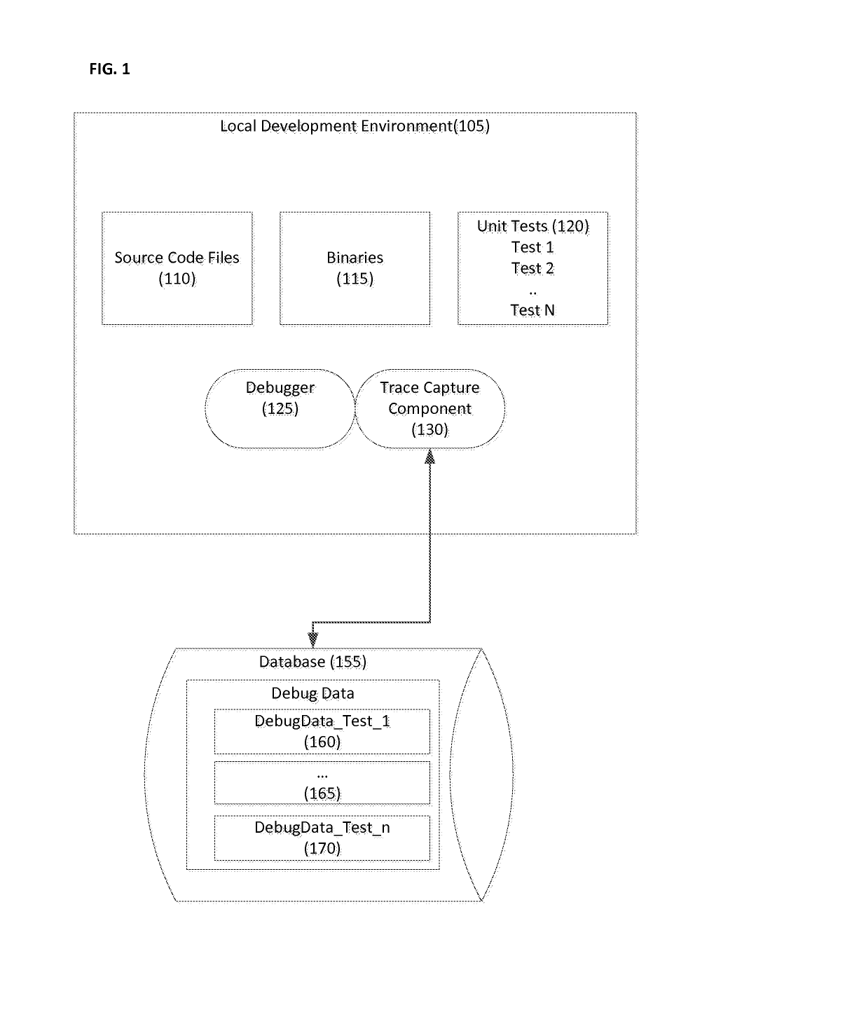

The example embodiment described herein includes the steps to generate, capture, store, and load debug data for a failed test script from a local development environment without a developer having to set up the debugging process or interact with an active debugger/debugging process. FIG. 1 depicts a local development environment (105) and a database (155). The local development environment (105) may contain source code files (110), executable binaries (115) associated with the source code files (110), unit tests (120) to be run against the binaries (115), a debugger (125) to generate the execution trace data, and a trace capture component (130) to implement the method described herein. The local development environment (105) described herein is only meant as an example and should not be considered to limit the scope of the invention. In some embodiments, a development environment (105) may be more sophisticated, with source code and binaries in multiple locations, requiring access to remote libraries and services. Also, a development machine may have integrated development environment software (IDE).

In an example embodiment, an IDE may manage the source code files, binaries, debugger, compiler, profiler, and other development components in an integrated software solution. This example embodiment describes a trace capture component's (130) functionality with these IDE elements. Although in this example the trace capture component (130) is depicted as a standalone component, in other examples, the component (130) may be integrated in the debugger (125), in an IDE as an extension, or on a server as a service.

FIG. 1 also depicts a database (155) that may store the debug data (160, 165, 170) including the associated execution trace and source code data for a failed unit test. Although in this example embodiment, only failed tests are handled and stored in the database (155), since generally only failed tests require debugging, this method is not limited to only failed tests and can be applied to all debugging, including successful unit tests and application testing in general.

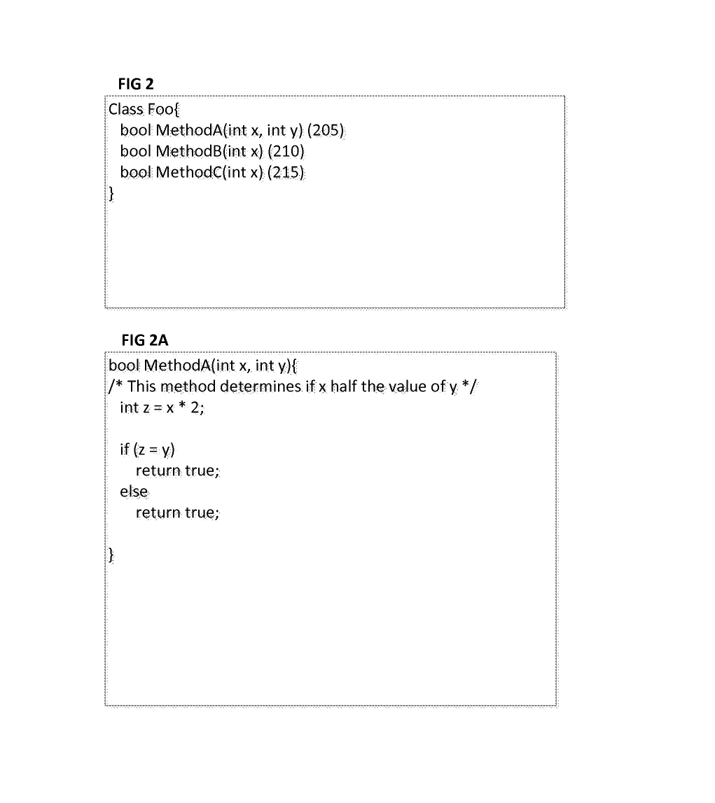

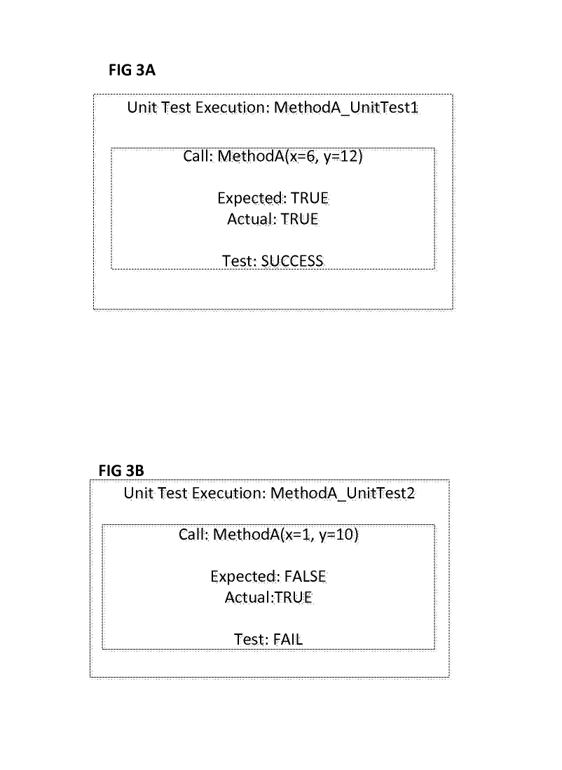

FIG. 2 is an example of a source code file for a class declaring three methods: MethodA (205), MethodB (210), and MethodC (215). FIG. 2A is example source code for one of the declared methods, MethodA (205). MethodA has two integer input parameters and can return a boolean value of either true or false. MethodA should return true if the first parameter, x, is half the value of the second parameter, y; otherwise, the method should return false. A well-constructed set of unit tests associated with this method will test both of these cases: 1) when the value of x is half the value of y, and 2) when the value of x is not half the value of y. Here, the source code erroneously always returns true, thus contains a bug. Therefore, a unit test for this method should test when the first parameter, x, is not half the value of the second parameter, y, and return a “FAIL” (as illustrated further below in FIG. 3B) to indicate a bug/error in the source code.

FIG. 3A is an example execution of a unit test associated with MethodA. MethodA_UnitTest1 calls MethodA with input parameters 6 and 12. In this example, the test is successful because the unit test tests whether the method returns true when the first parameter, x, is half the value of the second parameter, y. Since the value of 6 is half of 12, the test expects a return value of true and the method actually returns a value of true. Thus, the test passes.

FIG. 3B is an example execution of another unit test. MethodA_UnitTest2 also calls MethodA, but with input parameters of 1 and 10. Since 1 is not half the value of 10, the unit test expects a return value of false but the method actually returns a value of true. Thus, the unit test fails and raises an alert regarding a potential bug in the application.

Unit tests are only one means of executing and testing an application. The use of unit tests herein is only meant as an example and should not be considered to limit the scope of the invention. For example, other types of types of testing may include general (non-unit) test scripts, automated GUI test tools, or user driven testing. The method-focused-type of unit tests described herein, where one method is tested at a time, is also only an example and also should not be considered to limit the scope of the invention. The structure and complexity of unit tests, or other test strategies associated with an application in development, may vary based on the development and design of the application.

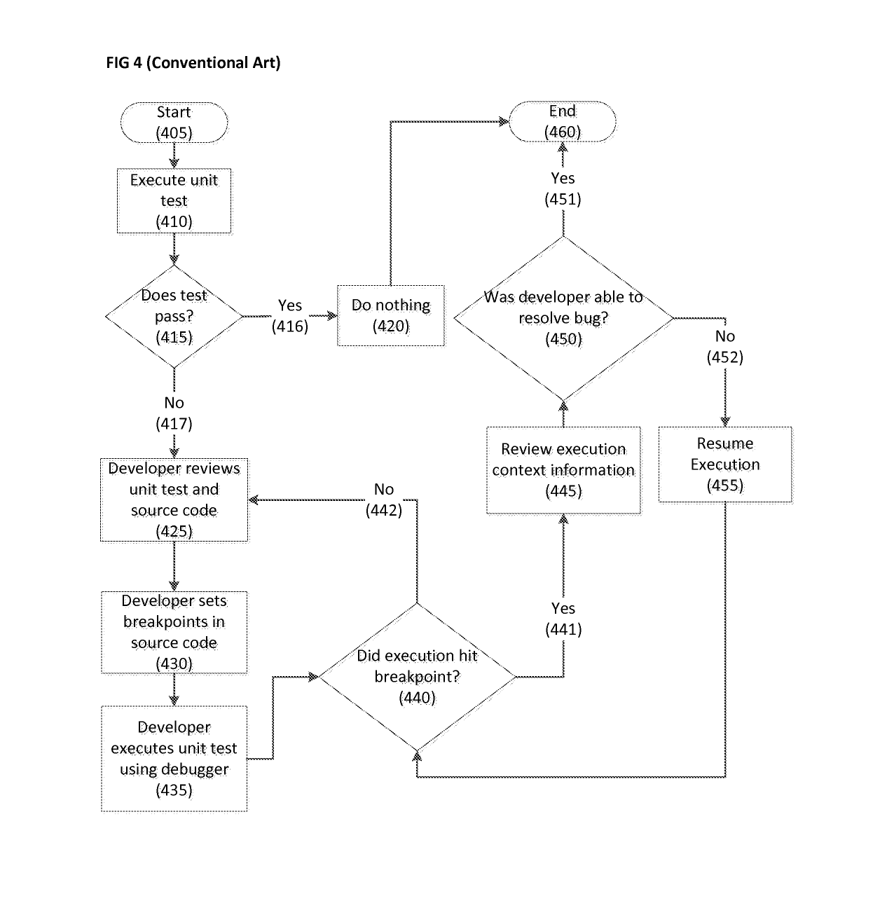

FIG. 4 is a flow diagram of a conventional method for debugging a unit test. Generally, all or a set of unit tests run automatically or are invoked by a developer when there has been a code change and the associated binaries of the application have been rebuilt. The unit tests run against this newly generated build to verify the build's integrity and detect any potential errors arising from the code changes. Conventionally, when a unit test fails, a developer goes through a manual process of setting breaking points in the source code and re-executing the application using a debugger as described in more detail herein to review the execution context information.

The conventional method begins (405) with the execution of a unit test (410). If the test passes (415, 416), no bugs have been detected, the developer does nothing (420). If the test fails (415, 417), the developer first reviews the unit test (425) and any associated errors to determine the areas of source code causing the failure. Next, the developer sets breakpoints in those areas of code (430) to instruct the debugger to halt the execution of the application at those points. Then the developer restarts the unit test using the debugger (435) to trace the application's execution. If the application execution reaches a breakpoint (440, 441), the debugger halts the execution of the application at that point and provides the developer the execution context information of the application. The developer reviews that information (445) to try and resolve the bug (450).

If the developer is able to resolve the bug (450, 451), the method is complete (460) and the developer can implement the necessary source code changes. However, if the developer is unable to resolve the bug (450, 452), the developer resumes the execution of the application (455). If another breakpoint is hit (440, 441), the execution is again halted and the developer repeats the steps of reviewing the execution context information (445) at the breakpoint to try and resolve the bug. Execution may continue with no breakpoints being hit (440, 442), i.e. the execution completes or terminates, and the bug still exists.

The developer then returns to the step of reviewing the unit test (425). As shown, this process can be very time consuming and tedious for a developer, potentially requiring multiple cycles of manually reviewing the unit tests, source code files, setting breakpoints, and re-executing the application. Also, it requires a developer to access the local development machine on which the application resides, run the application using the debugger, and manually set breakpoints in the associated source code to review the execution context information for the application.

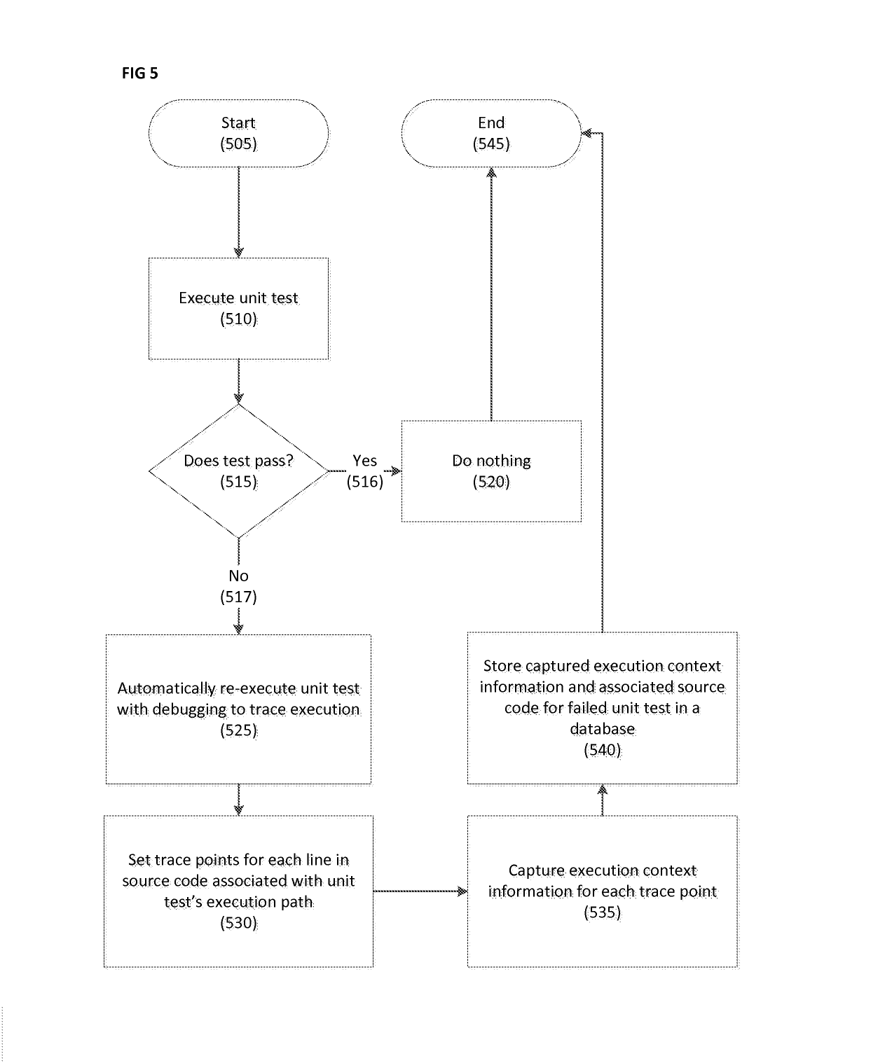

FIG. 5 is a flow diagram depicting the example method for generating, capturing, and storing the relevant debug data generated by a trace capture component following the execution of a failed unit test without any user interaction, according to the example embodiment. Although in this example embodiment, a “failed unit test” represents a case where an expected return value does not match the actual return value, it should not be considered to limit the scope of the invention. “Failed” may also include cases where the code is inefficient or non-performant.

An example method begins (505) with execution of a unit test (510). If the test passes (515, 516), the method may do nothing (520). If the test fails (515, 517), the example method may re-execute the unit test using a debugger and execution tracing enabled (525). This re-execution step is in contrast to the conventional method where the developer performs this step manually (435), perhaps multiple times (450, 452), and with a few other prior steps, such as reviewing the source code (425) and setting manual breakpoints (430). In this example method, the trace capture component may automatically set trace points for each line of source code associated with the unit test's execution path (530) and may capture the execution context information for each line of source code (535). The trace capture component may also be configured/optimized to capture and store the execution context information based on certain factors such as location, type, and size of source code files. These are only some example factors to improve the effectiveness and efficiency of the trace capture component/method and should not be considered to limit the scope of the invention.

In contrast, under the conventional method, the developer manually examines the unit test to determine the associated source code files (425) and manually sets breakpoints (430) in the associated source code to trace those code areas and review the execution context information (445) at those points.

In the example method, the captured relevant trace data (i.e. the execution context information and associated source code) may then be stored on and accessed from a database or other storage medium (540) for review by multiple developers. This completes the example method (545), the captured debug data for the unit test may now be used by any developer to debug the error without having to re-execute the application or access the local development machine. This is in sharp contrast to the conventional method where the developer accesses the local development machine and debugs the application while it is running.

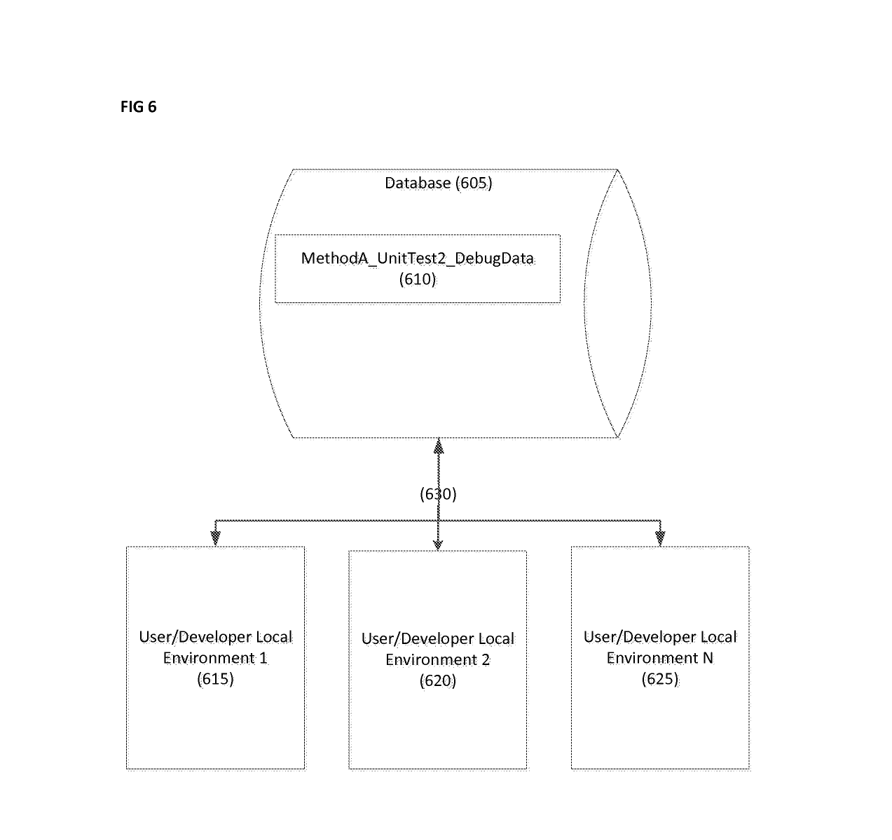

FIG. 6 is an example of a database (605) which contains the debug data for MethodA_UnitTest2 (610). Based on our example in FIG. 3B and the flow diagram FIG. 5, this should be the result when applying the method as described in the example embodiment. As shown, multiple users (615, 620, 625), such as the original developer or other developers on the team, can access and retrieve the debug data (630) (the captured execution context information and the associated source code for a unit test) into their local machine without having to re-execute the application or accessing the local development environment.

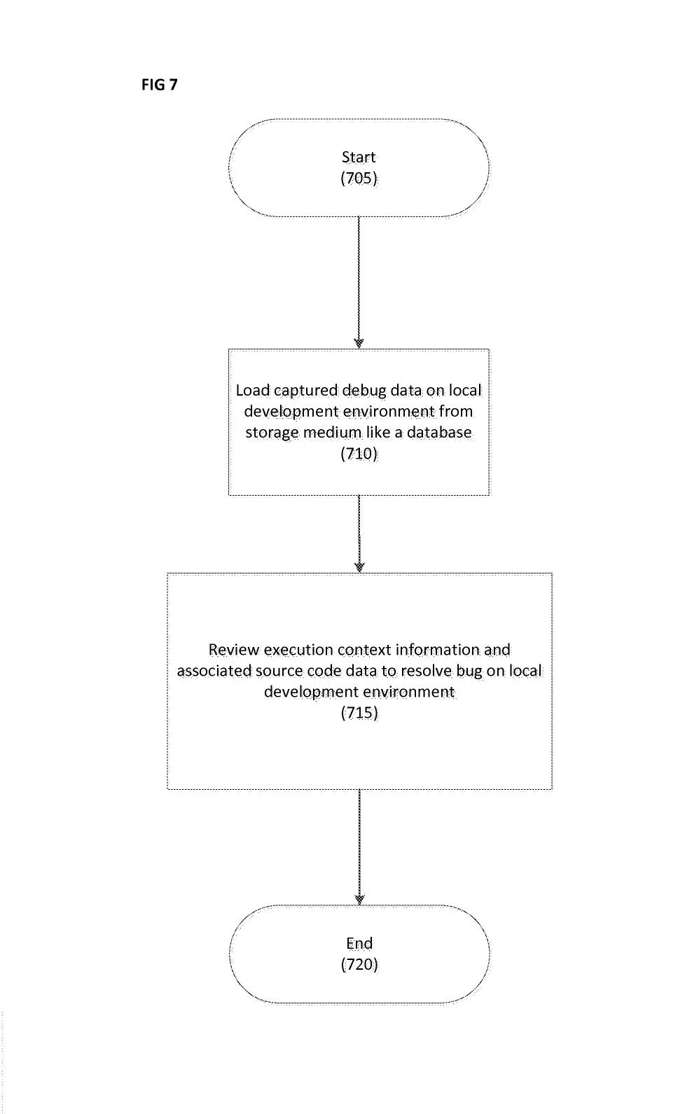

FIG. 7 is a flow diagram of a method of a developer debugging a unit test without requiring access to the original local development environment or re-execution of the application. An example method begins (705) where the developer may load debug data for a unit test (710) that may have been captured (as described in FIG. 5) and stored (as described in FIG. 6). Using that data, the developer may review the execution context and associated source code in a user interface like an integrated development environment software (IDE) to resolve the bug from their local machine (715) (i.e. not the original development machine) without re-executing the application or unit test.

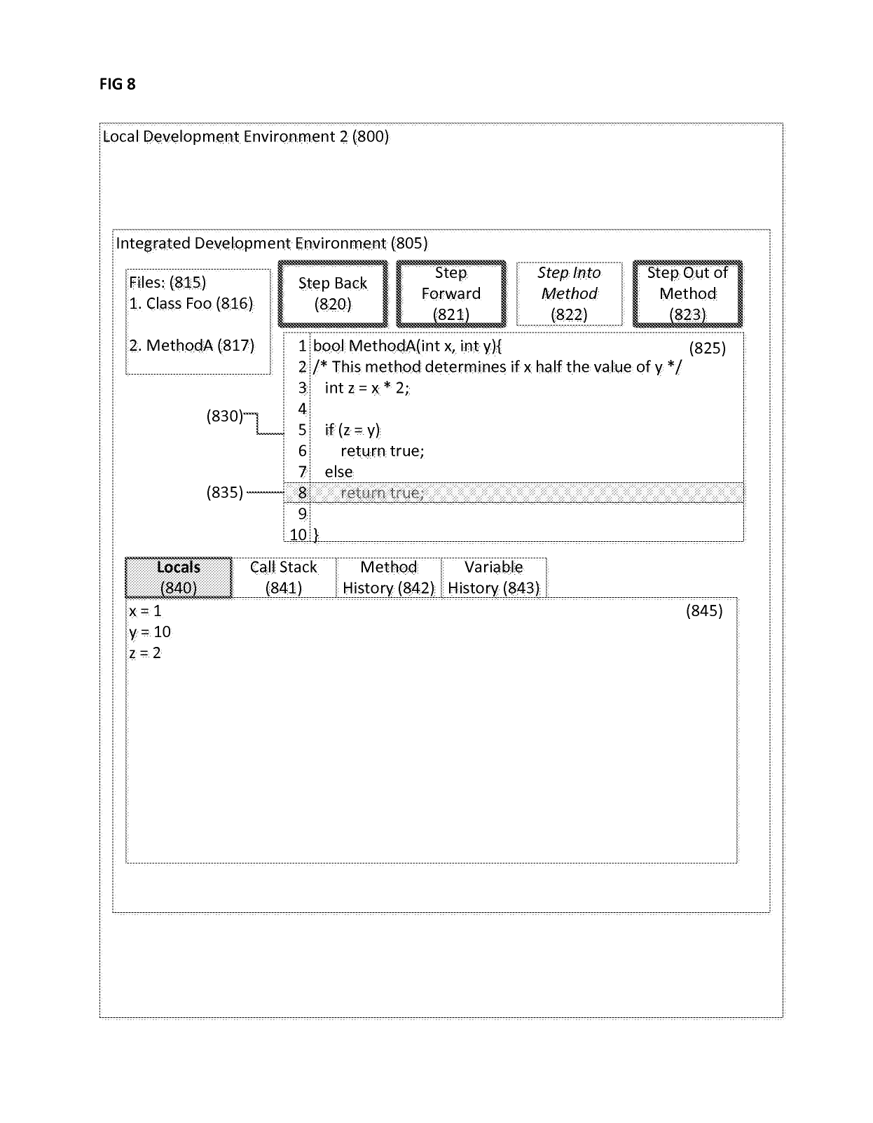

FIG. 8 is an example of a screenshot of an IDE user interface on a new development environment, in this case Local Development Environment 2, with debug data for MethodA_UnitTest2_DebugData. In this example, the debug data for the failed unit test has been captured, stored, and now loaded locally into a different new development environment, Local Development Environment 2 (800), than the original (105). This example UI depicts IDE software (805) which lists and allows a developer to select the associated source code files (815, 816, 817) for a unit test. The user interface also provides debugging capability, such as “step back” (820), “step forward” (821), “step into method” (822), and “step out of method” (823) options, to navigate through an application's execution trace, similar to when the application is actually executing on a local machine. Here, the “step into method” functionality is not enabled, since the execution point (835) is not on a line of code that is a method call. The captured debug data from the trace capture component allows a developer similar functionality to a debugger on the original local development environment. An internal window (825) also displays the relevant source code, in this case for MethodA, along with the line numbers (830). The current execution point (835) in the debugging process is also highlighted for the developer. The execution context information at that point (835) displayed in the window below (845). The highlighted current execution point (835) and the debugging information (840-845) are updated as the developer “steps” (820-823) or clicks to different lines (830) in the source code. The developer can also select the type of execution context information (840-843) to display, such as local variables information (840), call stack data (841), method history (842), or variable history (843). In this screenshot, “locals” (840) is selected which displays (845) the values of the local variables at the execution point (835) line 8 during the execution of the unit test. Now the developer can determine that in this case the local variables are loading correctly but the return value is incorrect, thus resolving the bug.

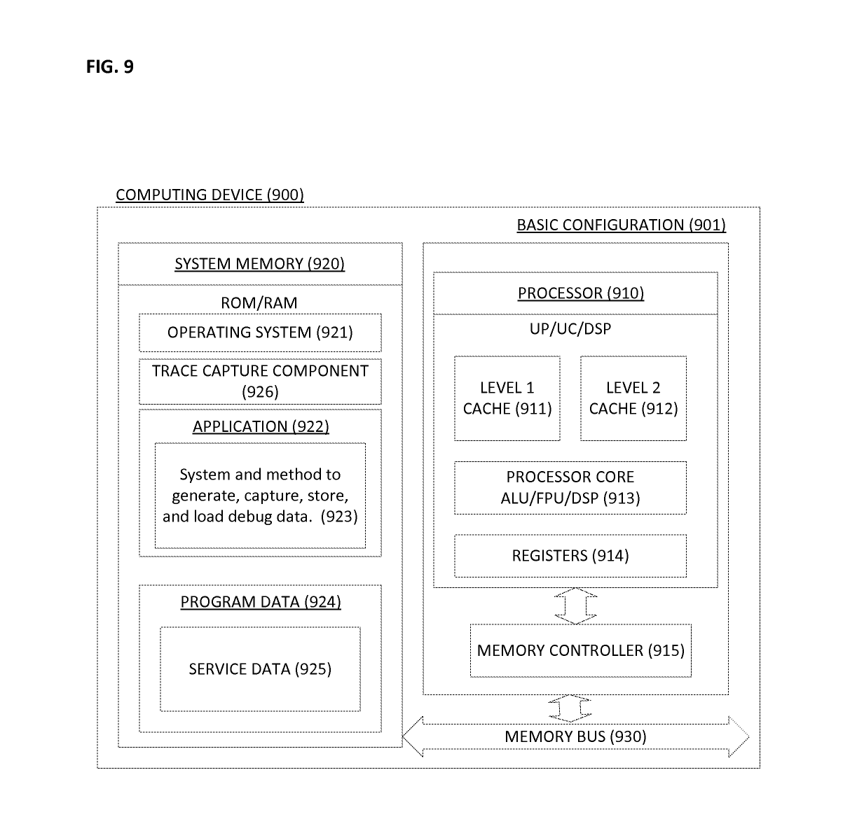

FIG. 9 is a high-level block diagram to show an application on a computing device (900). In a basic configuration (901), the computing device (900) typically includes one or more processors (910), system memory (920), and a memory bus (930). The memory bus is used to do communication between processors and system memory. The configuration may also include a standalone trace capture component (926) which implements the method described above, or may be integrated into an application (922, 923).

Depending on different configurations, the processor (910) can be a microprocessor (μP), a microcontroller (μC), a digital signal processor (DSP), or any combination thereof. The processor (910) can include one or more levels of caching, such as a L1 cache (911) and a L2 cache (912), a processor core (913), and registers (914). The processor core (913) can include an arithmetic logic unit (ALU), a floating point unit (FPU), a digital signal processing core (DSP Core), or any combination thereof. A memory controller (916) can either be an independent part or an internal part of the processor (910).

Depending on the desired configuration, the system memory (920) can be of any type including but not limited to volatile memory (such as RAM), non-volatile memory (such as ROM, flash memory, etc.) or any combination thereof. System memory (920) typically includes an operating system (921), one or more applications (922), and program data (924). The application (922) may include a trace capture component (926) or a system and method to generate, capture, store, and load debug data (923) of an execution of an application or a test. Program Data (924) includes storing instructions that, when executed by the one or more processing devices, implement a system and method for the described method and component. (923). Or instructions and implementation of the method may be executed via trace capture component (926). In some embodiments, the application (922) can be arranged to operate with program data (924) on an operating system (921).

The computing device (900) can have additional features or functionality, and additional interfaces to facilitate communications between the basic configuration (901) and any required devices and interfaces.

System memory (920) is an example of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer storage media can be part of the device (900).

The computing device (900) can be implemented as a portion of a small-form factor portable (or mobile) electronic device such as a cell phone, a smart phone, a personal data assistant (PDA), a personal media player device, a tablet computer (tablet), a wireless web-watch device, a personal headset device, an application-specific device, or a hybrid device that includes any of the above functions. The computing device (900) can also be implemented as a personal computer including both laptop computer and non-laptop computer configurations.

The foregoing detailed description has set forth various embodiments of the devices and/or processes via the use of block diagrams, flowcharts, and/or examples. In so far as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers, as one or more programs running on one or more processors, as firmware, or as virtually any combination thereof, and that designing the circuitry and/or writing the code for the software and/or firmware would be well within the skill of one skilled in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of non-transitory signal bearing medium used to actually carry out the distribution. Examples of a non-transitory signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium. (e.g., a fiber optic cable, a waveguide, a wired communications link, a wireless communication link, etc.)

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A method for integrating software test scripts and debugging without requiring user interaction, the method comprising:
executing software tests; and
responsive to at least one failing test, without requiring user interaction,
setting trace points at source code locations along the execution path of the at least one failing test;
executing the failing test with tracing, capturing the execution context information and associated source code for each trace point along the failing test's execution path until all the set trace points have been reached and the execution of the failing test is complete;
identifying execution information from the captured execution context information and the associated source code for each trace point reached during the execution of the failing test;
storing the execution information and the associated source code; and
providing the execution information of the failing test to a user via a user interface to help the user ascertain why the test is failing.

2-3. (canceled)

4. The method of claim 1 further comprising:
loading the stored execution information and associated source code data for debugging on a remote development environment.

5. The method of claim 1 further comprising:
storing and accessing the execution information and associated source code data from a database.

6. The method of claim 1 further comprising:
storing and accessing the execution information and associated source code data from a local development environment.

7. The method of claim 1 further comprising:
providing concurrent access to stored execution information and associated source code data to multiple users via storage medium like a database.

8. (canceled)

9. The method of claim 1 further comprising:
displaying the execution information and associated source code data in an integrated development environment (IDE).

10. A trace capture component for integrating software test scripts and debugging without requiring user interaction, the trace capture component comprising:
one or more processing devices to receive status of the software test script;
one or more storage devices storing instructions that, when executed by the one or more processing devices, cause the one or more processing devices to:
execute software tests; and
responsive to a failing test, without requiring user interaction,
set trace points at source code locations along the execution path of the failing test;
execute the failing test with tracing, capturing the execution context information and associated source code for each trace point along the failing test's execution path until all the set trace points have been reached and the execution of the failing test is complete;
identify execution information from the captured execution context information and the associated source code for each trace point reached during the execution of the failing test;
store the execution information and the associated source code; and
provide the execution information of the failing test to a user via a user interface to help the user ascertain why the test is failing.

11-12. (canceled)

13. The trace capture component of claim 10 further comprising:
loading stored execution information and associated source code data for debugging on a remote development environment.

14. The trace capture component of claim 10 further comprising:
storing and accessing stored execution information and associated source code data from a database.

15. The trace capture component of claim 10 further comprising:
storing and accessing stored execution information and associated source code data from a local development environment.

16. The trace capture component of claim 10 further comprising:
providing concurrent access to stored execution information and associated source code data to multiple users.

17. The trace capture component of claim 10 further comprising:
displaying the execution information and associated source code data in an integrated development environment (IDE).
